(19) United States
(12) Patent Application Publication
(10) Pub. No.: US 2010/0291266 A1
(43) Pub. Date: Nov. 18, 2010

(54) Natural Sponge Food and Regimen

(76) Inventor: Tibor Czinki, Mitchellville, MD (US)

Correspondence Address: SHOEMAKER AND MATTARE, LTD, 10 POST OFFICE ROAD - SUITE 100, SILVER SPRING, MD, 20910, US

(21) Appl. No.: 12/466,699

(22) Filed: May 15, 2009

(51) Int. Cl. A23L 1/302; A23L 1/31

(52) U.S. Cl. 426/72; 426/92

(57) ABSTRACT

A portion of a natural sponge is compressed into a capsule which can be swallowed. The capsule dissolves in the stomach, allowing to sponge to expand and fill a substantial portion of the stomach to give a feeling of fullness and to suppress the appetite. Nutritious foods and dietary supplements may be consumed contemporaneously. The sponge portion, which passes through the human body without being dissolved, may be cleaned and reused. Another portion of natural sponge may be kept in the mouth to promote salivation and improve digestion.

### BACKGROUND OF THE INVENTION

This invention relates to a natural sponge food and regimen.

A person's natural appetite should and usually does lead one to a healthy diet: one which contains not only necessary nutrients, but also a certain amount of non-digestible material, which is regarded as an important to the health of the colon. Unfortunately, the natural tendency toward a healthy diet is in many people overcome by bad training, bad advice, or natural imbalance. Moreover, obesity is a recognized major health problem in many countries, and the pressures of advertizing and ubiquitous “fast” foods encourage overeating.

The appetite for food can be suppressed by filling the stomach with a bulky substance, such as cellulose, which is low in nutritional value. A number of popular diet products take this approach.

Sponges are animals of the phylum Porifera. Although there are freshwater species, the great majority are marine species. Calcareous sponges produce spicules made of calcium carbonate, whereas demosponges reinforce the mesohyl with fibers of a special form of collagen called spongin. Demosponges constitute about 90% of all known species, including all freshwater ones, and have the widest range of habitats.

Most demosponges also produce spicules of silica, and a few secrete massive external frameworks of calcium carbonate. The few species of demosponge that have entirely soft fibrous skeletons with no hard elements have been used by humans over thousands of years for several purposes, including as padding and as cleaning tools. However, they were so over-fished that nowadays most sponge-like materials are synthetic. These species are referred to herein as “soft natural sponges”.

Because of their chemical toxins and for many species their spicules, sponges have only a few predators (the angelfish is one).

Humans cannot digest natural sponge; nevertheless, I have found that soft natural sponge can be ingested in capsule form and that doing so can produce a number of health benefits beyond appetite suppression. Some of the benefits are listed further below.

I have also found that maintaining a piece of natural sponge in the mouth, between the cheek and teeth or gum, promotes salivation, which not only prevents dry mouth, but also promotes digestion. A related advantage is that by promoting salivation, the sponge reduces ones' tendency to keep the mouth open, keeps the sinuses clear and helps prevent sleep apnea.

Improved salivation reduces cravings for food, and is believed to reduce cravings for other substances such as alcohol and nicotine as well. Salivation is also important to dental health, as saliva flow naturally irrigates the teeth and removes foreign matter from them.

By stimulating the salivary glands, a piece of natural sponge in the mouth thins the saliva, reducing the need to cough (which may interrupt sleep). Similarly, the sinuses are kept more clear, a benefit particularly for those having nasal allergies.

### SUMMARY OF THE INVENTION

An object of this invention is to fill the stomach with a natural product which can be compressed and swallowed in capsule form.

A related object is to suppress hunger to help one lose weight.

Another object is to provide a digestive aid which is not itself digested and can be recycled.

A further object is to provide a food or supplement which is not bulky when compressed.

Yet another object is to improve salivation and thereby improve digestion and suppress cravings.

These and other objects are attained by a natural sponge food and regimen as described below.

### BRIEF DESCRIPTION OF THE DRAWINGS

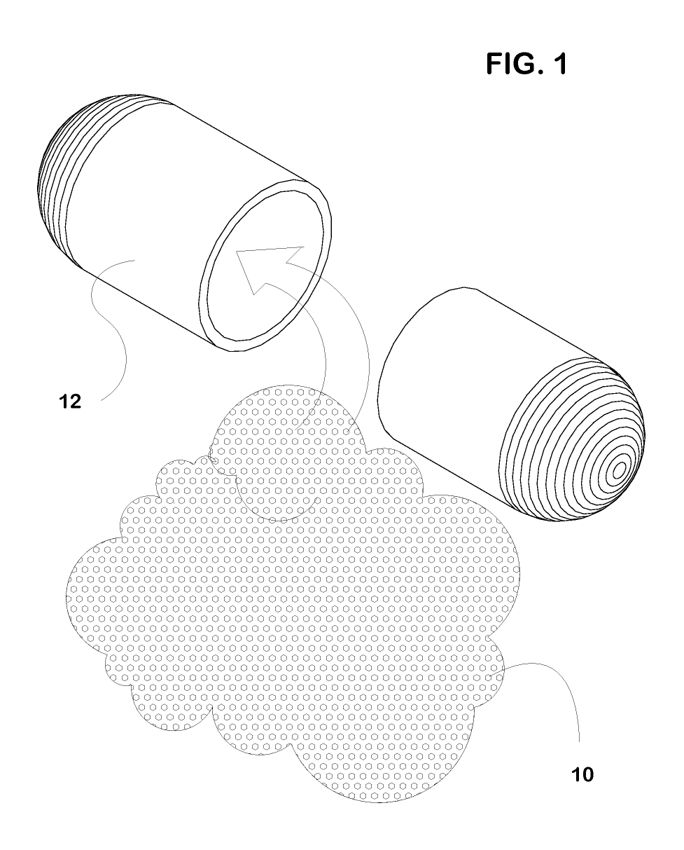

In the accompanying drawings, FIG. 1 is an exploded perspective view of a capsule containing a compressed natural sponge portion.

### DESCRIPTION OF THE PREFERRED EMBODIMENT

A product embodying the invention is shown in FIG. 1. It comprises a portion 10 of a natural sponge which has been cleaned of debris and sanitized. The sponge is chemically treated (e.g., with a bleach or muriatic acid) to make it consumable and remove foreign matter such as nutrients which could adversely affect storage life.

The sponge portion 10 is tightly compressed into a gelatin capsule 12. The capsule is designed to dissolve in the stomach, releasing the sponge portion, which then expands to many times its compressed size so as to occupy a substantial portion of the volume of the stomach.

Inasmuch as natural sponge is not digestible by humans, a sponge portion remains in the human stomach for some time as the gastric juices digest other foods which have been ingested. Eventually, the sponge passes with the digested food into and through the intestines; however, it does not interfere with digestion. In fact, improved digestion has been observed, even though the sponge itself does not contribute substantial nutritional value to the person.

The sponge is eventually excreted and may be recovered, thoroughly cleaned, sanitized are re-used if desired. The possibility of recycling makes the invention interesting for use by astronauts, who must maximize recycling and already recycle urine, for example.

The invention may be practiced in a regular regimen, for example, daily, or more preferably three times a day, before each meal.

As mentioned above, a piece of natural sponge may be placed in the mouth and maintained there for prolonged periods of an hour or more. Doing so promotes salivation and thereby promotes digestion. This practice is useful particularly in combination with the regimen described above. Inasmuch as the sponge is highly compressible, its presence in the mouth is not noticeable to others, and it does not interfere with drinking. The user may prefer to remove the mouth sponge during meals.

I have practiced the above regimens, including the oral sponge placement, continuously for three years. I have found it beneficial and have observed the benefits described below.

Weight loss: By partially filling the stomach, the sponge helps provide a feeling of fullness and discourages overeating.

Improved energy: By reducing food consumption, the invention reduces the amount of body resources needed for digestion.

Sleeping: One can fall asleep faster and sleep more restfully because the invention enables the digestive system to work more efficiently and prevents over-fullness.

Body odor: The invention reduces or eliminates body odor by intercepting toxic material in the digestive system and preventing such material from being absorbed by the body.

Bladder: Irritation of the bladder is minimized or eliminated as the sponge intercepts and absorbs irritants, salts and toxins in the stomach and intestines. By reducing the amount of such substances which reach the blood stream, the invention indirectly reduces the burden on the kidneys and the concentration of the substances in the urine.

Memory: By preventing toxins from entering the blood stream, the brain is better served and better memory retention is observed.

Regularity: The invention promotes intestinal health, increases the frequency of normal bowel movements and reduces the occurrence of constipation and diarrhea.

Tension: The effect of having a piece of sponge in the mouth is like that of a pacifier. Reducing tension generally reduces the frequency of headaches and stomach aches.

Further benefits which I have observed include reductions in arthritis, bursitis, headaches, eye fatigue, neck stiffness, muscle spasms and cramps.

Since the invention is subject to modifications and variations, it is intended that the foregoing description and the accompanying drawings shall be interpreted as only illustrative of the invention defined by the following claims.

I claim:

1. A natural food comprising
a portion of a soft natural sponge compressed within a capsule, the capsule being made of a material which dissolves in gastric juices so as to release the sponge portion, allowing it to expand and occupy a substantial part of the volume of the stomach, thereby providing a sensation of fullness without inhibiting normal digestion of other ingested foods.

2. The natural food of claim 1, wherein the sponge is free of nutrients and dietary supplements.

3. A health regimen comprising steps of
orally ingesting a portion of a soft natural sponge which has been compressed within a capsule, the capsule being made of a material which dissolves in the stomach and contemporaneously
orally ingesting nutritious foods and/or dietary supplements.

4. The regimen of claim 3, wherein said steps are performed at least once a day.

5. The regimen of claim 3, wherein said steps are performed at least three times a day.

6. The regimen of claim 3, wherein said supplements are vitamins.

7. The regimen of claim 3, wherein said supplements are minerals.

8. The regimen of claim 3, further comprising a step of maintaining a portion of a soft natural sponge in the mouth for a prolonged period to stimulate salivation and reduce cravings.

9. A health regimen comprising a step of maintaining a portion of a soft natural sponge in the mouth for a prolonged period to stimulate salivation and reduce cravings.
